(19) United States
(12) Patent Application Publication
(10) Pub. No.: US 2025/0012617 A1
(43) Pub. Date: Jan. 9, 2025

(54) System for storing liquids

(71) Applicant: emz-Hanauer GmbH & Co. KGaA, Nabburg (DE)

(72) Inventors: Lukas Schade, Nabburg (DE); Johann KLEBER, Nabburg (DE); Veronika RUIDER, Nabburg (DE)

(21) Appl. No.: 18/750,054

(22) Filed: Jun. 21, 2024

(30) Foreign Application Priority Data
Jul. 7, 2023 (DE) 102023118047.9

(51) Int. Cl. G01F 23/292

(52) U.S. Cl. CPC G01F 23/292

(57) ABSTRACT

The invention relates to a system for storing liquids, in particular for a household appliance, comprising at least one container for storing a liquid and at least one level measuring device, wherein the level measuring device comprises at least one radiation source device which emits electromagnetic radiation and at least one detection device for electromagnetic radiation, wherein the at least one container has a reflective element which has only one boundary surface with a fluid located in the container.

### CROSS-REFERENCE TO RELATED APPLICATIONS

This patent application claims the benefit of and priority to German Patent Application No. 102023118047.9, filed on Jul. 7, 2023, which is herein incorporated by reference in its entirety.

### FIELD OF THE DISCLOSURE

The invention relates to a system for storing liquids, in particular for a household appliance, comprising at least one container for storing a liquid and at least one level measuring device.

### BACKGROUND

Many appliances and devices, especially household appliances, include containers for storing various liquids. A corresponding household appliance could be a water-bearing household appliance, for example a dishwasher or a washing machine. Detergent, rinse aid or other treatment agents could be stored in the at least one container. However, it is also conceivable that the container could be a storage means for condensation water in a household appliance, for example a refrigerator or a dryer. It is often desirable to obtain information about the fill level of such containers. Such information could be used to indicate the need for filling or emptying.

### SUMMARY

The task of the present invention is to provide a system for storing liquids which makes it particularly easy to determine the fill level.

The problem is solved by the entity of claim 1. The subclaims comprise preferred embodiments.

According to the present invention, there is provided a system for storing liquids, in particular for a household appliance, comprising at least one container for storing a liquid and at least one level measuring device, wherein the level measuring device comprises at least one radiation source device which emits electromagnetic radiation and at least one detection device for electromagnetic radiation, wherein the at least one container has a reflective element which has only one boundary surface with a fluid located in the container.

If electromagnetic radiation hits a boundary surface between materials with different refractive indices, some of the radiation is reflected and some of the radiation enters the neighbouring material. This behaviour depends on the so-called angle of incidence α of the electromagnetic radiation. In geometrical optics, the angle of incidence α refers to the angle between the ray and the horizon being completed to 90°. When a beam passes through an optical boundary surface, its angle of incidence is that of the perpendicular to this surface. If the angle of incidence α is greater than the critical angle α_{T}, total reflection of the radiation occurs. The radiation is therefore completely reflected. The critical angle α_{T} is defined as follows:

$$sin {α}_{T} = \frac{{n}_{1}}{{n}_{2}}$$

where n₁ and n₂ are the refractive indices of the neighbouring materials. Preferably, mi is the refractive index for air or fluid. Advantageously, the refractive index of air nₐᵢᵣ is smaller than the refractive index of the fluid n_{fluid} (nₐᵢᵣ<n_{fluid}). Preferably, n₂ is the refractive index for the material of the reflective element. Preferably, the critical angle α_{T} of the electromagnetic radiation from the at least one radiation source device is determined from the refractive index n of the reflective element.

Preferably, the electromagnetic radiation from the at least one radiation source device strikes the boundary surface at a predetermined angle of incidence α or a predetermined range of angles of incidence. In an advantageous first state of the system, the container is not filled with the liquid. Accordingly, the fluid in the container is preferably air. In the first state of the system, the reflective element thus preferably has a boundary surface with air. In an advantageous second state of the system, the container is filled with the fluid. Accordingly, the fluid in the container is preferably the corresponding liquid. In the second state of the system, the reflective element thus preferably has a boundary surface with the corresponding liquid. Preferably, in the first state of the system, at least a portion of the electromagnetic radiation is totally reflected at the only one boundary surface. Preferably, the reflected portion is detected by the at least one detection device. Advantageously, in the second state, there is no total reflection of the at least one radiation source device emitted electromagnetic radiation from the only one boundary surface at the predetermined angle of incidence a.

In the system according to the invention, only one boundary surface is provided with a fluid in the container, at which total reflection takes place. In contrast to otherwise conceivable embodiments with two adjacent boundary surfaces enclosing a predetermined angle, the system according to the invention requires significantly less design effort for the at least one container.

According to a preferred embodiment, the reflective element is arranged in or on an outer wall of the container. Preferably, the boundary surface of the reflective element is planar. A planar boundary surface extends flat or planar without curvatures or the like. According to a further possible embodiment, the boundary surface is curved, parabolic or in the form of a spherical section. According to a further aspect, an optical element may be integrated into the boundary surface. Such an optical element can be a lens, for example. Advantageously, the reflective element comprises a material that is transparent to the electromagnetic radiation emitted by the at least one radiation source device. Preferably, the reflective element is made of glass or a polymer, for example polymethyl methacrylate (PMMA, also acrylic glass). Preferably, the reflective element can also have several sections made of different materials.

According to another preferred embodiment, the at least one container is a hollow body that is essentially rectangular or square in shape. However, other shapes would also be conceivable, for example bodies with a polygon-shaped or rounded base. The container extends along a height axis Z, a longitudinal axis X and a width axis Y. If there is liquid in the container, the liquid has a level or an upper surface. This level essentially extends within a plane which is spanned by the longitudinal axis X and the width axis Y. However, the orientation of the level depends on the installation of the at least one container in a household appliance, for example, or on the orientation of the container in relation to the gravitational force acting on it.

According to a further preferred embodiment, the reflective element comprises an optical prism. Advantageously, a first lateral surface of the optical prism forms only a boundary surface with a fluid present in the container. The prism can be a prism of any shape. Preferably, the first side surface forming the boundary surface is planar. The prism can preferably have interruptions along its length. The prism can preferably contain optically active structures, for example lens elements and/or a surface roughness to support scattering.

According to a preferred embodiment, the optical prism has a straight prism with a triangular base. Such a prism preferably comprises a first, a second and a third side surface. Preferably, emitted electromagnetic radiation from the at least one radiation source device enters the optical prism through a second lateral surface of the optical prism and reaches the first lateral surface of the optical prism or the boundary surface. In a first state, at least a portion of this electromagnetic radiation is totally reflected at the boundary surface and then exits the optical prism through the third side surface. From there, the reflected radiation advantageously reaches the at least one detection device.

According to a further advantageous embodiment, the reflective element is arranged on or in the outer wall of the at least one container in such a way that the boundary surface is inclined or at an angle to a fictitious plane parallel to the level of the liquid. Preferably, the reflective element is arranged on or in the outer wall of the at least one container in such a way that the boundary surface forms an angle θ with a fictitious plane parallel to the level of the liquid. Preferably, the angle θ is less than 180°.

According to a further advantageous embodiment, the reflective element is arranged on or in the outer wall of the at least one container in such a way that the boundary surface is essentially parallel to a level of the liquid in the container. Advantageously, the angle θ is essentially equal to 180°. Preferably, the first lateral surface of the optical prism is arranged substantially parallel to the level of the liquid.

According to a preferred embodiment, the reflective element comprises a window element, which in turn comprises the boundary surface. Preferably, the window element is integrated in an outer wall of the at least one container. The window element can be planar, curved, parabolic or in the form of a spherical section.

According to a further advantageous embodiment, the radiation source device comprises at least one radiation source. Preferably, the at least one radiation source is an LED, a laser or a laser LED. Of course, other suitable radiation sources would also be conceivable. Preferably, the electromagnetic radiation emitted by the radiation source device has a wavelength λ in a range between approximately 300 nm and approximately 1400 nm. Preferably, the electromagnetic radiation emitted by the at least one radiation source device is polarised. Preferably, the electromagnetic radiation is linearly, circularly or elliptically polarised. Preferably, the at least one radiation source device already emits the polarised electromagnetic radiation. Alternatively, the radiation source device may comprise at least one polariser. According to a further preferred embodiment, the electromagnetic radiation emitted by the at least one radiation source device is unpolarised. In this case, although the reflectivity below the critical angle would be dependent on the polarisation directions, the critical angle is the same for the different polarisation angles.

Preferably, the at least one detection element comprises at least one sensor element. Such a sensor element is preferably suitable and intended for detecting electromagnetic radiation. Such a sensor element can be a phototransistor, for example.

According to a further advantageous embodiment, the at least one radiation source device and the at least one detection device are arranged on a common carrier device. Preferably, the carrier device comprises at least one plate-like element. Preferably, the plate-like element is a card, circuit board or PCB (printed circuit board). It is conceivable that the carrier device comprises a housing in which the at least one plate-like element is arranged.

According to a further advantageous embodiment, a central beam direction is assigned to the at least one radiation source device and the at least one detection device. The at least one radiation source device has an emission angle β_{E}. The emission angle β_{E} describes the area in which the electromagnetic radiation propagates from the at least one radiation source device. Preferably, the emission of the at least one radiation source device is not isotropically distributed within the emission angle. In the case of a radiation source device in the form of an LED, a wide variety of emission behaviours are possible. Such emission behaviours can be lobe-like, have a so-called batwing characteristic or have a side-emitter characteristic. Of course, other characteristics are also conceivable. Preferably, the at least one detection device has an acceptance angle β_{A}. The acceptance angle β_{A} describes the range in which the electromagnetic radiation propagates towards the at least one detection device. Preferably, the detection efficiency of the at least one detection device is not isotropic within the acceptance angle. Accordingly, the central beam direction of the at least one detection device would extend along the centre height axis of said conc.

Preferably, the central beam direction of the at least one radiation source device and/or the central beam direction of the at least one detection device does not extend perpendicular to the plate-like element of the carrier device. A central beam direction of the at least one radiation source device, which is not perpendicular to the plate-like element of the carrier device, can preferably be made possible by at least one radiation source device, which has at least one radiation source that is designed as a component with bent wire connections. Alternatively or cumulatively, the at least one radiation source can be an SMD LED (surface mounted LED) with a tilted optical axis or a side-looker LED.

A central beam direction of the at least one detection device not perpendicular to the plate-like element of the carrier device can preferably be made possible by at least one detection device which has a sensor element which is designed as a component with bent wire connections. Preferably, said wire connections of the radiation source and/or the sensor element are arranged on the circuit board by means of a through-hole mounting (also called through-hole technology or THT).

According to a further preferred embodiment, the carrier device comprises a curved board. Preferably, the one such curved board is mechanically stable. According to a further aspect, the carrier device could comprise a flexible board. Preferably, the board comprises a first section on or at which the at least one radiation source device is arranged. Furthermore, it is advantageous that the board has a second section on or at which the at least one detection device is arranged. Preferably, the first section and the second section form an angle γ. Preferably, the angle γ is less than 180°. Such an advantageous design with the two sections enclosing the angle γ can be made possible by a curved board or a flexible board.

According to a further preferred embodiment, the at least one radiation source device has an emission angle β_{E} and the at least one detection device has an acceptance angle β_{A}. Preferably, the at least one radiation source device is arranged relative to the boundary surface such that at least a portion of the electromagnetic radiation strikes the boundary surface within the emission angle β_{E}. Preferably, the at least one acceptance angle of the detection device is arranged relative to the boundary surface such that at least a portion of the reflected electromagnetic radiation is within the acceptance angle β_{A}.

According to a further preferred embodiment, the at least one radiation source device is arranged relative to the boundary surface in such a way that only a portion of the electromagnetic radiation within the emission angle β_{E} strikes the boundary surface. Preferably, the at least one radiation source device has a large emission angle β_{E}. Preferably, the at least one radiation source device is approximately a Lambert radiator. Preferably, the at least one radiation source device has at least one radiation source which is approximately a Lambert radiator. A Lambertian radiator follows Lambert's cosine law, which states that a radiant intensity observed from an angle θ_{L} (relative to the surface normal) is proportional to cos (θ_{L}). Preferably, the emission of the at least one radiation source device is not isotropically distributed within the emission angle. With such a design, the at least one radiation source device can be attached to the circuit board in such a way that it is essentially parallel to the circuit board. Preferably, the proportion of electromagnetic radiation that impinges on the boundary surface is sufficient to enable adequate detection.

Preferably, the at least one detection device is arranged relative to the boundary surface in such a way that only a part of the reflected electromagnetic radiation lies within the acceptance angle β_{A}. Preferably, at least one detection device has a large acceptance angle β_{A}. Preferably, at least one detection device is approximately a Lambert detector. Such a Lambert detector is to be defined analogously to the Lambert radiator described above. Preferably, the at least one detection device has at least one sensor element which is approximately a Lambert detector. By such an embodiment, the at least one detection device can be attached to the circuit board in such a way that this is essentially parallel to the circuit board. Preferably, the proportion of electromagnetic radiation that impinges on the at least one detection device is sufficient to enable adequate detection.

Preferably, both the at least one radiation source device is approximately a Lambert radiator and the at least one detection device is approximately a Lambert detector.

Preferably, half the emission angle (β_{E}) is greater than or equal to 45°. Preferably, half the acceptance angle (β_{A}) is greater than or equal to 45°. Advantageously, the emission angle (β_{E}) and the acceptance angle (β_{A}) are to be understood analogously to the definition of the aperture angle in the definition of the numerical aperture. Such an aperture angle of an optical system preferably corresponds to the maximum possible angle of a light beam that emanates from the focussed object and is just picked up by the lens. The aperture angle indicates how large the maximum light cone is that is captured by the lens from the object.

According to a further preferred embodiment, at least one first aperture device is provided which spatially limits the electromagnetic radiation directed onto the boundary surface. Preferably, at least one second aperture device is provided, which spatially limits the reflected electromagnetic radiation. It is also conceivable that at least one third aperture device is provided, which both spatially limits the electromagnetic radiation directed onto the boundary surface and spatially limits the reflected electromagnetic radiation. Preferably, the at least one first aperture device and/or the at least one second aperture device and/or the at least one third aperture device is designed as a pinhole aperture or a slit aperture. If a radiation source device with a large emission angle β_{E} is used, irradiation in undesired areas can thus be prevented. Undesired irradiation from the reflected radiation can also be avoided.

According to a further preferred embodiment, a first window element is arranged between the at least one radiation source device and the boundary surface. Preferably, a second window element is arranged between the boundary surface and the at least one detection device.

According to a further preferred embodiment, a first optical element is arranged on or close to the at least one radiation source device. Preferably, a second optical element is arranged on or close to the at least one detection device. Advantageously, the first optical element and/or the second optical element is a prism or a lens.

According to a further advantageous embodiment, at least one radiation guiding device is provided. Preferably, the electromagnetic radiation of the at least one radiation source device is guided in sections in the radiation guiding device. Preferably, the electromagnetic radiation reflected at the boundary surface is guided in sections in the radiation guiding device. Preferably, the radiation source device is rod-shaped and comprises a bevelled distal end. Preferably, the electromagnetic radiation passing through the radiation source device is totally reflected at the bevelled distal end and redirected to the boundary surface. Preferably, the electromagnetic radiation reflected at the boundary surface is totally reflected at the bevelled distal end and directed to the radiation source device.

According to a further advantageous embodiment, a plurality of containers is provided for storing a liquid. Advantageously, only one radiation source device is provided. Preferably, a plurality of radiation guiding devices is provided, which guide electromagnetic radiation of the radiation source device to the respective boundary surfaces of the containers. Advantageously, a plurality of detection devices is provided. Preferably, a detection device is assigned to each container.

It is understood that the above embodiments can be combined as desired. Thus, the at least one radiation source device of one embodiment can be combined with the at least one detection device of another embodiment.

The task is also solved by a household appliance with a system for storing liquids. The household appliance can be equipped with all the features already described above as part of the system, cither individually or in combination with one another, and vice versa.

According to a particularly preferred embodiment, the system for storing liquids is part of a dispensing appliance. Preferably, the household appliance is a water-bearing household appliance, for example a dishwasher or a washing machine. Preferably, the liquid stored in the at least one container is a treatment agent, for example a detergent, a rinse aid, a rinse aid, a fabric softener or the like. Preferably, the at least one container is removable from the dispensing device.

Preferably, the household appliance is a dryer, with the container being used to store the condensation water from the dryer. The system for storing liquids can be used, for example, to determine that one of the containers needs to be emptied.

### BRIEF DESCRIPTION OF THE DRAWINGS

Further advantages, objectives and features of the present invention are explained with reference to the following description of the attached figures. Similar components may have the same reference signs in the various embodiments.

FIG. 1 a side view of the system according to one embodiment;

FIG. 2 a perspective view of the system according to one embodiment;

FIG. 3 a side view of the system according to one embodiment;

FIG. 4 a perspective view of the system according to one embodiment;

FIG. 5 a section of an arrangement of the system according to one embodiment;

FIG. 6 a system according to an unfavourable embodiment;

FIG. 7 a schematic comparison of an unfavourable and an advantageous design;

FIG. 8 reflectivity measurement curves as a function of the angle of incidence;

FIG. 9 a section of an arrangement of the system according to a further embodiment;

FIG. 10 a section of an arrangement of the system according to a further embodiment;

FIG. 11 a section of an arrangement of the system according to a further embodiment;

FIG. 12 a section of an arrangement of the system according to a further embodiment;

FIG. 13 a section of an arrangement of the system according to a further embodiment;

FIG. 14 a section of an arrangement of the system according to a further embodiment;

FIG. 15 a section of an arrangement of the system according to a further embodiment;

FIG. 16 a section of an arrangement of the system according to a further embodiment;

FIG. 17 a section of an arrangement of the system according to a further embodiment;

FIG. 18 a section of an arrangement of the system according to a further embodiment;

FIG. 19 a section of an arrangement of the system according to a further embodiment;

FIG. 20 a section of an arrangement of the system according to a further embodiment;

FIG. 21 a section of an arrangement of the system according to a further embodiment;

FIG. 22 a section of an arrangement of the system according to a further embodiment; and

FIG. 23 a schematic diagram of a household appliance according to one embodiment.

### DETAILED DESCRIPTION

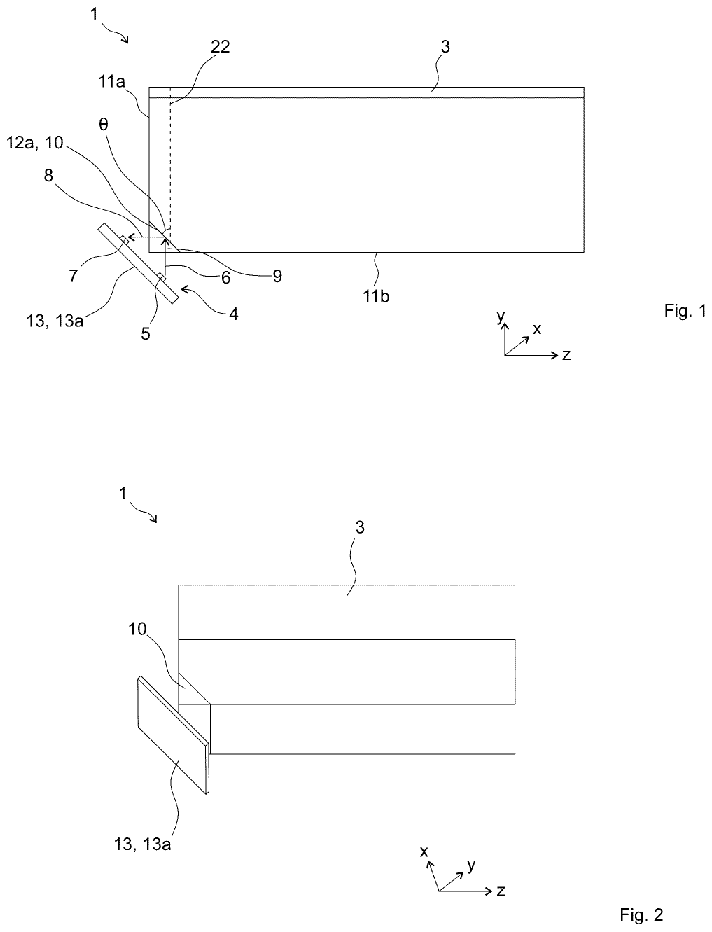

FIGS. 1-5 and 9-22 show a system 1 for storing liquids, in particular for a household appliance 2. The system 1 comprises at least one container 3 for storing a liquid and at least one level measuring device 4, wherein the level measuring device 4 comprises at least one radiation source device 5 which emits electromagnetic radiation 6 and at least one detection device 7 for electromagnetic radiation 8, wherein the at least one container 3 has a reflective element 9 which has only one boundary surface 10 with a fluid located in the container 3.

The at least one container 3 extends along a height axis Z, a longitudinal axis X and a width axis Y. The container 3 is a hollow body that is essentially rectangular or square in shape. However, other shapes would also be conceivable, for example bodies with a polygonal or rounded base. The container 3 also comprises an outer wall 11. If there is liquid in the container 3, the liquid has a level or an upper surface. This level extends essentially within a plane which is spanned by the longitudinal axis X and the width axis Y.

The reflective element 9 is arranged in or on an outer wall 11 of the at least one container 3. The boundary surface 10 can be planar, curved, parabolic or in the form of a spherical section. According to an advantageous embodiment, an optical element can also be integrated into the boundary surface 10. The reflective element 6 can also be made of glass or a polymer.

The electromagnetic radiation 6 of the at least one radiation source device 5 strikes the boundary surface 10 at a predetermined angle of incidence α or a predetermined angle of incidence range. In a first state of the system, the container 3 is not filled with the liquid. The boundary surface is therefore at the fluid air. Accordingly, there is a transition from the material of the reflective element 9, for example glass or Plexiglas, to air. Due to such a transition, in the first state of the system at least a portion of the electromagnetic radiation 6, which hits the boundary surface at a predetermined angle of incidence a, is totally reflected at the only one boundary surface 10. The reflected electromagnetic radiation 8 is then detected by the at least one detection device 7. In a second state of the system, the container 3 is filled with the liquid. In the second state of the system, there is therefore a transition from the material of the reflective element 9, for example glass or Plexiglas, to the liquid. As a result of such a transition, there is no total reflection of the electromagnetic radiation 6 at the single boundary surface 10 at the specified angle of incidence a. Such a lack of total reflection at the predetermined angle of incidence α can also be detected by the at least one detection device 7. The boundary surface 10 can also be referred to as an optically active surface.

The reflective element 9 comprises an optical prism 12, a first lateral surface 12a of the optical prism 12 forming only a boundary surface 10 with a fluid located in the container 3. The prism can have fundamentally different shapes; in the following, without limiting the generality, reference is made to a straight prism with a triangle as the base surface. The emitted electromagnetic radiation 6 enters the prism 12 through a second side surface 12b and reaches the boundary surface 10 or the first side surface 12a. When the system is in the first state, the electromagnetic radiation 6 is totally reflected at the boundary surface 10 and then exits the prism 12 through the third side surface 12c as reflected electromagnetic radiation 8.

The radiation source device 5 comprises at least one radiation source 5a. The at least one radiation source 5a can be an LED, a laser or a superluminescent diode (SLED).

The at least one radiation source device 5 and the at least one detection device 7 are arranged on a common carrier device 13. The carrier device 13 comprises a plate-like element 13a or a printed circuit board (PCB), on which the at least one radiation source device 5 and the at least one detection device 7 are mounted. It is conceivable that the carrier device 13 comprises a housing (not shown in the figures) in which the at least one plate-like element 13a is arranged.

FIG. 6 shows an embodiment which is considered unfavourable. According to this embodiment, two boundary surfaces with the fluid, which may be air or the liquid, exist in the container 3. The incident electromagnetic radiation 6 is reflected at the first boundary surface to the second boundary surface. The electromagnetic radiation is then reflected from the second boundary surface to the detection device. However, the presently claimed invention has only one boundary surface to the fluid in the container. The embodiment according to the invention has the advantage that a structurally simpler construction of the container is made possible. The geometry of the container can be simplified. If the internal structures of the container are disadvantageously more complicated, the stored liquid can remain on the surfaces more easily after emptying. The reason for this is the surface tension on edges with an angle<180°. FIG. 7 compares the non-advantageous embodiment under a) with embodiment b) according to the invention. In contrast to the non-advantageous embodiment, the embodiment according to the invention has further advantages with regard to tolerances. The non-advantageous embodiment a) has translational tolerances X′=0, Y′=2X and Z=0. In contrast, the embodiment b) according to the invention has translational tolerances X′=1.41 (sqrt2), Y′=2X and Z=0. The non-advantageous embodiment a) has angular tolerances X′=4X′, Y′=4X′ and Z=4X′. In contrast, embodiment b) according to the invention has angular tolerances X′=2X′, Y′=2X′ and Z=2X′. The embodiment according to the invention thus has better translational tolerances and better angular tolerances, since total reflection only occurs at one boundary surface.

FIGS. 1 and 2 show an embodiment of the system, wherein FIG. 1 is a side view and FIG. 2 is a perspective view. It can be seen from these figures that the reflective element 9, for example a prism 12, is arranged in or on the outer wall 11 of the at least one container 3 in such a way that the boundary surface 10 is inclined or runs obliquely to a fictitious plane 22, which is parallel to the level of the liquid. The boundary surface 10 and the fictitious plane 22 thus include an angle θ that is less than 180°. The boundary surface 10 extends obliquely between a bottom outer wall 11a and a lateral outer wall 11b. The boundary surface 10 is thus essentially arranged laterally on the lower area of the container. The figure clearly shows that a corner section of the container has been replaced by the reflective element 9 due to the course of the boundary surface 10. The circuit board 13a, on which the at least one radiation source device 5 and the at least one detection device 7 are arranged, is arranged essentially parallel to the boundary surface 10.

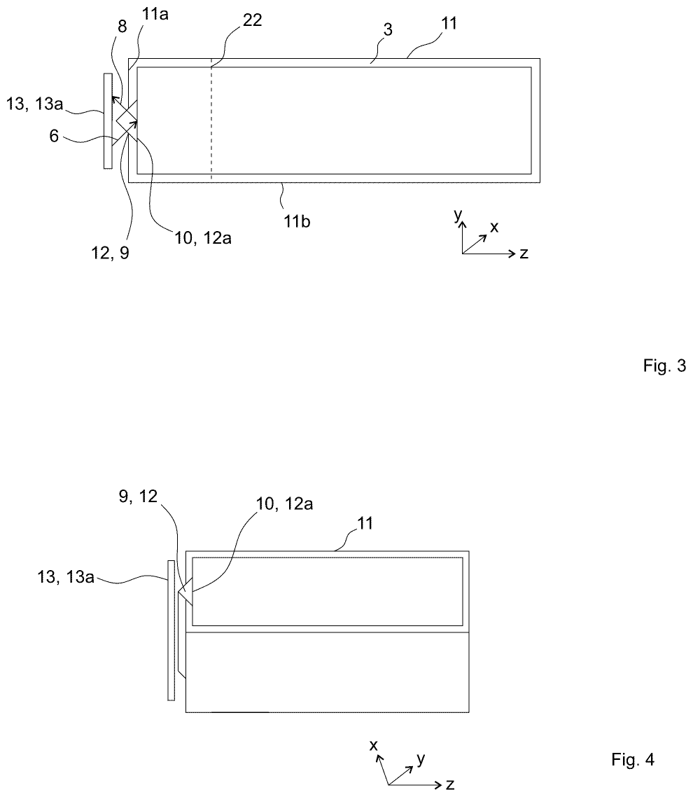

FIGS. 3 and 4 show a further embodiment of the system, wherein FIG. 3 is a side view and FIG. 4 is a perspective view. It can be seen from these figures that the reflective element 9, for example a prism 12, is arranged on or in the container 2 in such a way that the boundary surface 10 runs essentially parallel to a fictitious plane 22, which is parallel to the level of the liquid. The boundary surface 10 and the fictitious plane 22 thus include an angle θ which is essentially 180°. The boundary surface 10 is arranged in or on the bottom outer wall 11a. The circuit board 13a, on which the at least one radiation source device 5 and the at least one detection device 7 are arranged, is arranged substantially parallel to the boundary surface 10.

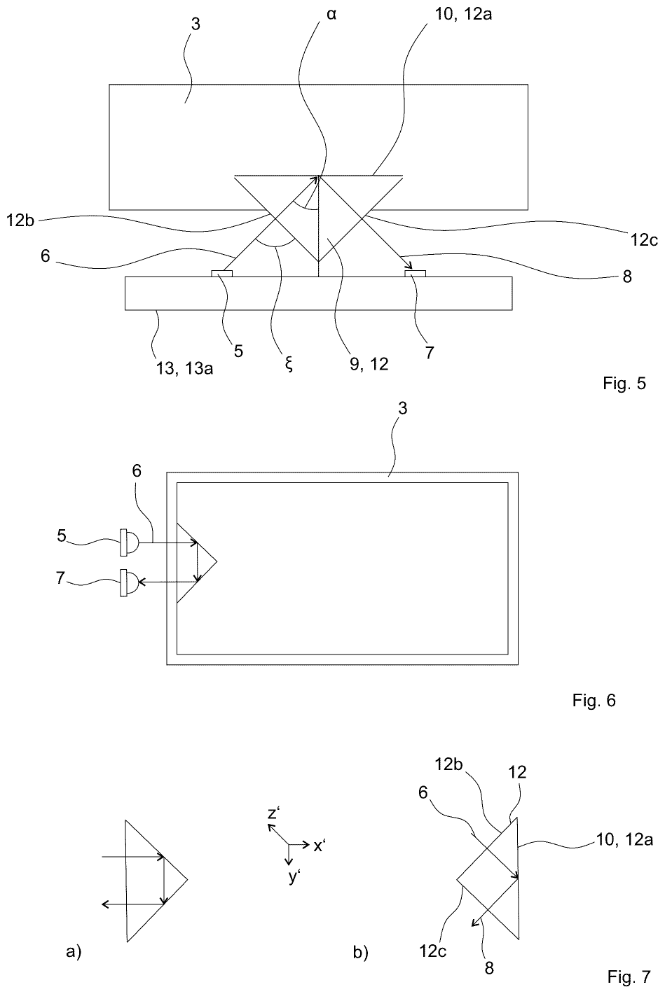

FIG. 5 shows a section showing the prism 12, the carrier device 13 with the at least one radiation source device 5 and the at least one detection device 7 as well as the beam paths of the emitted electromagnetic radiation 6 and the reflected electromagnetic radiation 8. The angle ξ between the emitted electromagnetic radiation 6 and the second side surface 12b of the prism 12 can be 90°. However, other angles are also conceivable. The angle of incidence α depends on the respective material of the prism or the refractive index n of this material.

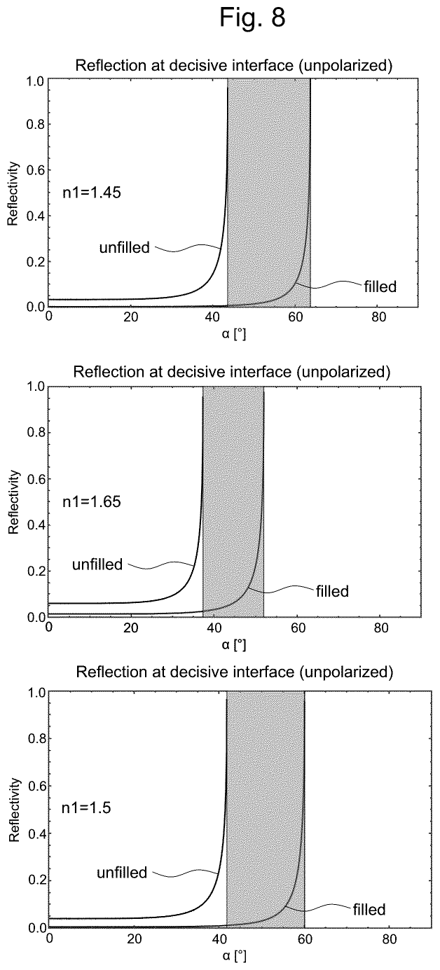

FIG. 8 shows the reflectivity as a function of the angle of incidence α (unpolarised radiation) for different materials of the reflective element 9. In graph a), the refractive index of the material is n₁=1.45. In graph b), the refractive index of the material is n₁=1.65. In graph c), the refractive index of the material is n₁=1.55. The graphs also show the angular dependence of the total reflectivity in an unfilled state, in which the fluid at the boundary surface 10 is air, and a filled state, in which the fluid at the boundary surface 10 is liquid. In the unfilled state, the critical angle α_{T} is approximately 43° at n₁=1.45, the critical angle α_{T} is approximately 37° at n₁=1.65, and the critical angle α_{T} is approximately 41° at n₁=1.5.

The at least one radiation source device 5 has an emission angle β_{E}. The emission angle β_{E} describes the range in which the electromagnetic radiation 6 propagates from the at least one radiation source device 5. The at least one detection device has an acceptance angle β_{A}. The acceptance angle β_{A} describes the range in which the electromagnetic radiation propagates towards the at least one detection device. Furthermore, a central beam direction 6a, 8a is assigned to the at least one radiation source device 5 and the at least one detection device 7.

The central beam direction 6a of the at least one radiation source device 5 and/or the central beam direction 8a of the at least one detection device 7 preferably do not extend perpendicular to the plate-like element 13a. This allows the electromagnetic radiation 6 to be incident at the predetermined angle of incidence α and the reflected electromagnetic radiation 8 to be detected at only one boundary surface 10.

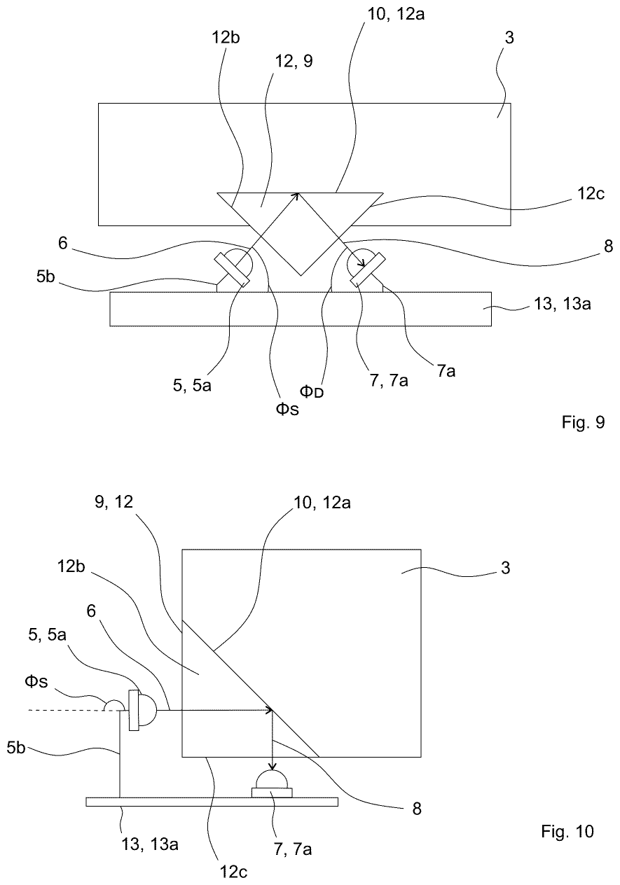

FIG. 9 shows an embodiment in which both the central beam direction 6a of the at least one radiation source device 5 and the central beam direction 8a of the at least one detection device 7 do not extend perpendicular to the plate-like element 13a. Of course, embodiments are conceivable in which only the at least one radiation source device 5 or the at least one detection device 7 have a central beam direction 6a, 8a which does not extend perpendicular to the plate-like element 13a. In order to enable such a central radiation direction 6a, which does not extend perpendicular to the plate-like element 13a, the at least one radiation source device 5 can, for example, comprise at least one radiation source 5a, which is designed as a component with bent wire connections 5b: Alternatively or cumulatively, the at least one detection device 7 can comprise a sensor element 7a, which is designed as a component with bent wire connections 7b. The central beam direction 6a of the at least one radiation source device 5 and the circuit board 13a thus include an angle ϕ_{S} which is less than 90°. The central beam direction 8a of the at least one detection device 7 and the circuit board 13a thus include an angle ϕ_{D} that is less than 90°. The figure also clearly shows that the respective component is not parallel to the circuit board 13a and is therefore attached to it at a certain distance from the surface of the circuit board. The respective wire connections 5b, 7b are attached to the circuit board using through-hole technology. Another possibility for enabling at least one radiation source device 5 with a central beam direction 6a that does not extend perpendicular to the board-like element 13a is the use of sidelooker LEDs.

FIG. 10 shows an embodiment in which only the central beam direction 6a of the at least one radiation source device 5 does not extend perpendicular to the plate-like element 13a. The central beam direction 8a of the at least one detection device 7 extends essentially perpendicular to the plate-like element 13a. According to this embodiment, the central beam direction 6a of the at least one radiation source device 5 is essentially parallel to the plate-like element 13a. The angle ϕ_{S} is therefore essentially 0°. However, the plate-like element 13a is arranged relative to the container in such a way that the boundary surface 10 extends at an angle to it. An angle between a plane in which the boundary surface 10 is located and between a plane in which the plate-like element 13a is located is thus less than 90° and greater than 0°, preferably this angle is in a range between 20° and 70°. According to this embodiment, at least one radiation source 5a of the radiation source device 5 is designed as a component with bent wire connections 5b. The radiation source 5a is not parallel to the circuit board 13a and is thus attached to the circuit board at a certain distance from its surface. The respective wire connections 5b are attached to the circuit board using through-hole technology.

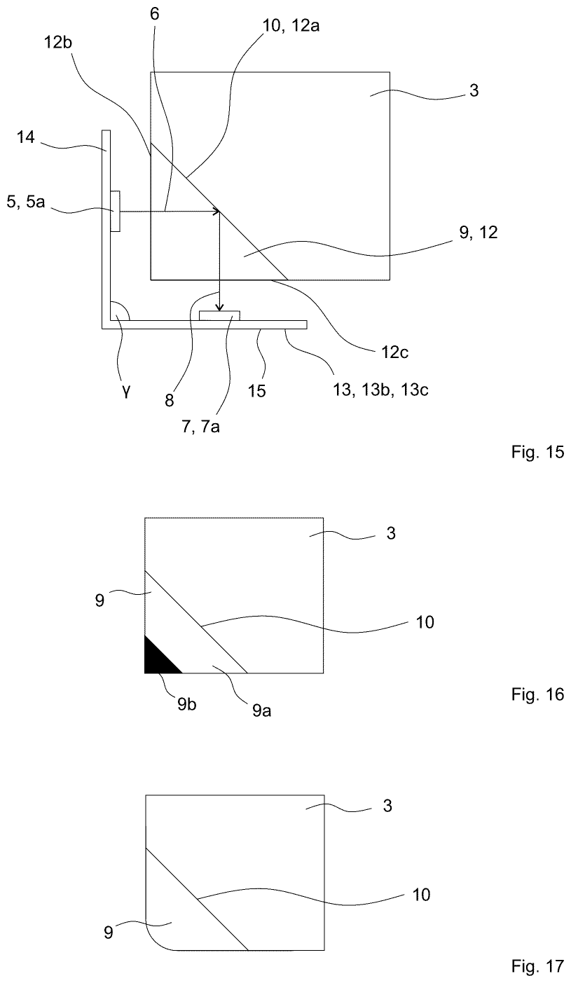

FIG. 15 shows an alternative embodiment. Here, the circuit board 13, 13b, 13c has a first section 14 on or at which the at least one radiation source device 5 is arranged. Furthermore, the board 13, 13b, 13c has a second section 15 on or at which the at least one detection device 7 is arranged. The first section 14 and the second section 15 enclose an angle γ which is less than 180°. Such a configuration can be made possible by a curved board 13b or a flexible board 13c. The board 13b, 13c is arranged relative to the container 3 in such a way that the boundary surface 10 extends at an angle to both the first section 14 and the second section 15. An angle between a plane in which the boundary surface 10 is located and between a plane in which a section 15 is located is thus less than 90° and greater than 0°, preferably this angle is in a range between 20° and 70°. The at least one radiation source device 5 and the at least one detection device 7 can thus be arranged essentially parallel to a surface of the respective section.

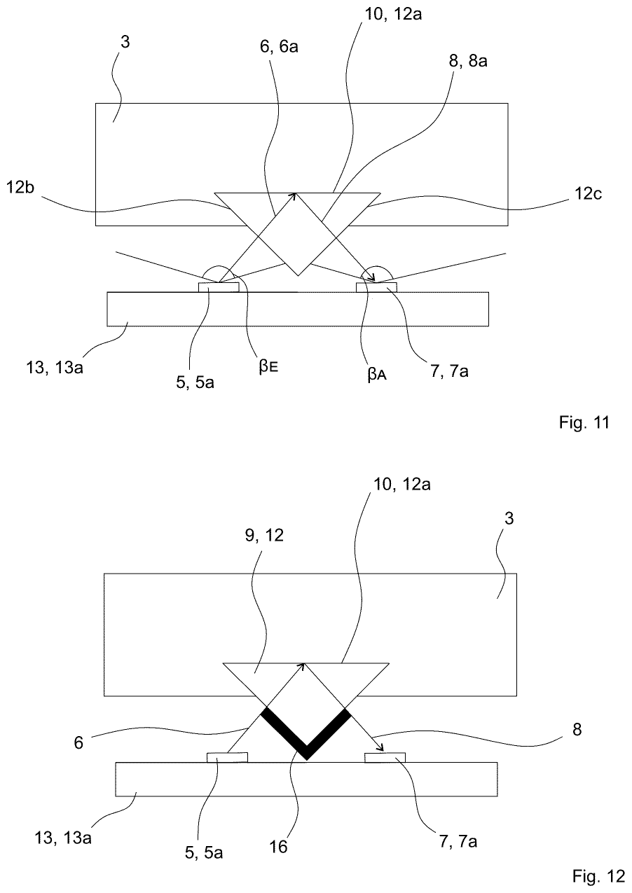

According to a further embodiment, the at least one radiation source device 5 is selected such that it has a large emission angle β_{E}. Preferably, the at least one radiation source device 5 is approximately a Lambert radiator. Alternatively or cumulatively, the at least one detection device 7 is selected such that it has a large acceptance angle β_{A}. Preferably, at least one detection device 7 is approximately a Lambert detector. Such a radiation source device 5 and such a detection device 7 are provided in the embodiment according to FIG. 11. The at least one radiation source device 5 is arranged relative to the boundary surface 10 in such a way that only a portion of the electromagnetic radiation 6 within the emission angle β_{E} strikes the boundary surface 10. Furthermore, the at least one acceptance angle of the detection device 7 is arranged relative to the boundary surface 10 in such a way that only a portion of the reflected electromagnetic radiation 8 is within the acceptance angle (β_{A}). Due to the large emission angle β_{E}, sufficient electromagnetic radiation 6 hits the boundary surface 10. Due to the large acceptance angle β_{A}, sufficient reflected electromagnetic radiation 8 hits the at least one detection device 7 to enable effective detection. According to this embodiment, the circuit board 13a is essentially parallel to the boundary surface 10. Furthermore, the at least one radiation source device 5 and the at least one detection device 7 are essentially parallel to the circuit board 13a.

According to one embodiment, at least one first aperture device is provided, which spatially limits the electromagnetic radiation 6 directed onto the boundary surface 10. Alternatively or cumulatively, at least one second aperture device may be provided, which spatially limits the reflected electromagnetic radiation 8. FIG. 12 shows an embodiment which essentially corresponds to the embodiment shown in FIG. 11. Furthermore, a third aperture device 16 is provided, which is a combination of a first aperture device and a second aperture device. The third aperture device 16 thus spatially limits both the electromagnetic radiation 6 directed onto the boundary surface 10 and the reflected electromagnetic radiation 8. In the present case, the third aperture device 16 is V-shaped and is arranged at or near the prism 12 and between at least one radiation source device 5 and the at least one detection device 7.

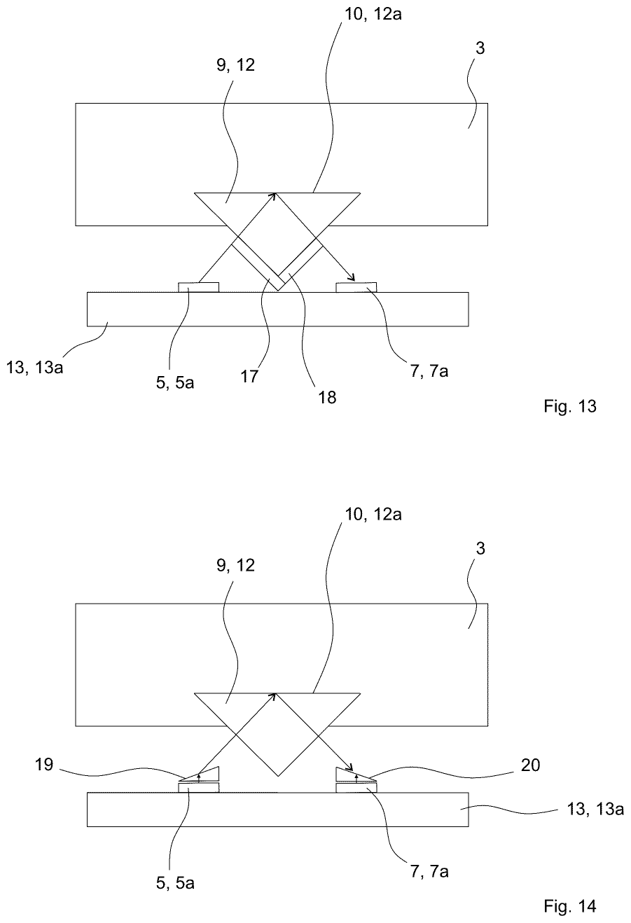

FIG. 13 shows an embodiment which essentially corresponds to the embodiment shown in FIG. 11. Furthermore, a first window element 17 is arranged between the at least one radiation source device 5 and the boundary surface 10. Alternatively or cumulatively, an additional second window element 18 may be arranged between the boundary surface 10 and the at least one detection device 7. It is also conceivable that the two window elements 17, 18 are combined to form one element. FIG. 13 shows such a combined element. This is V-shaped and is arranged at or near the prism 12 and between at least one radiation source device 5 and the at least one detection device 7.

FIG. 14 shows an embodiment that essentially corresponds to the embodiment shown in FIG. 11. Furthermore, a first optical element 19 is arranged on or near the at least one radiation source device 5. Alternatively or cumulatively, a second optical element 20 may be arranged on or close to the at least one detection device 7. The first optical element 19 and/or the second optical element 20 may, for example, be a prism or a lens.

The reflective element 9 can be designed in a variety of ways. For example, the reflective element 9 can have several sections 9a, 9b, which are made of different materials. This is shown in FIG. 16. A first section 9a consists of a first material and a second section 9b consists of a second material. According to the embodiment shown in FIG. 17, the reflective element 9 has a rounded section opposite the boundary surface 10.

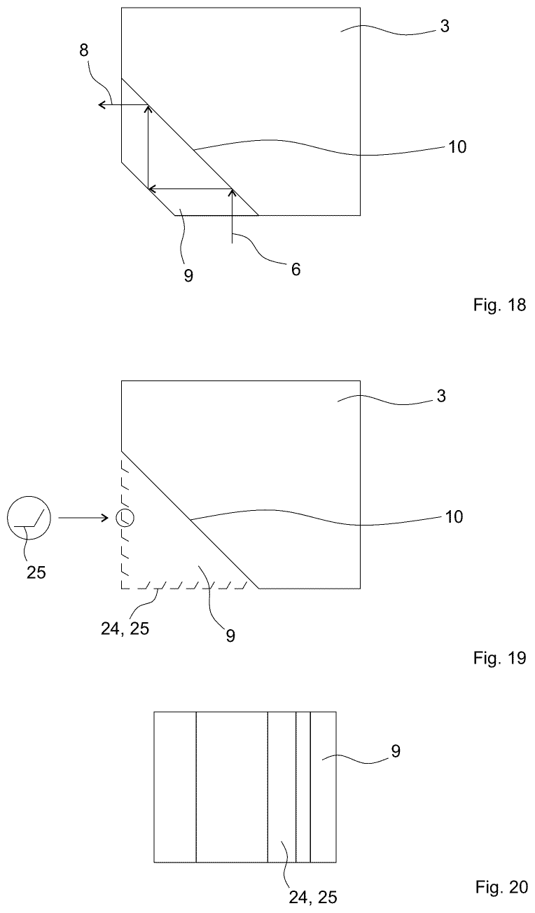

According to the embodiment shown in FIG. 18, the reflective element 9 has an additional interface 23 which, however, is not in contact with the fluid in the container 3, be it air or the liquid. Rather, this additional interface 23 is arranged opposite the boundary surface 10. Accordingly, several reflections of the electromagnetic radiation 6 can take place in the reflective element 9 before it emerges from the reflective element 9.

According to the embodiment shown in FIGS. 19 and 20, the reflective element 9 has a boundary area 24, which consists of a plurality of segments 25. Preferably, these segments 25 are angled. The boundary area is of course transparent to the electromagnetic radiation 6, 8.

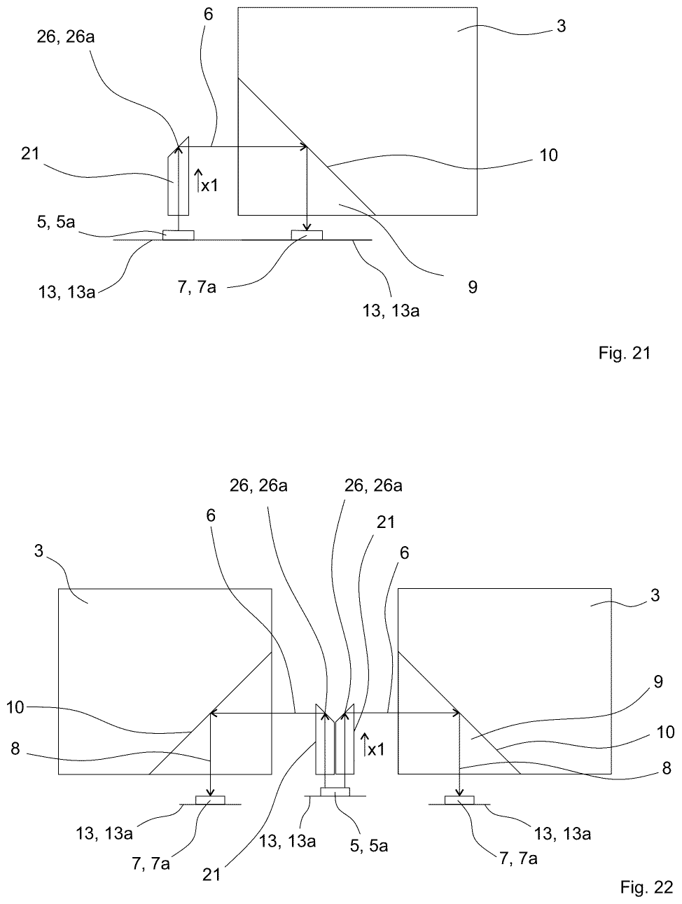

According to one embodiment, at least one radiation guiding device 21 is provided. In this case, the electromagnetic radiation 6 of the at least one radiation source device 21 is guided in sections in the radiation guiding device 21. Alternatively or cumulatively, the electromagnetic radiation 8 reflected at the boundary surface is guided in sections in the radiation guiding device 21. In FIG. 21, for example, a radiation guiding device 21 is provided. In this radiation guiding device 21, electromagnetic radiation 6 from the one radiation source device 5 is guided along a section of the beam path, in this case the vertical section.

According to the embodiment shown in FIG. 21, a radiation guiding device 21 is provided. The radiation guiding device 21 is rod-shaped, arranged above the radiation source device 5 and substantially perpendicular to the radiation source device 5 or the circuit board 13a. The radiation guiding device 21 has a distal end 26, wherein the surfaces 26a of the distal ends 26 are each bevelled by 45 degrees with respect to a longitudinal direction X1 of the radiation guiding device 21. The first electromagnetic radiation 6 propagating in the longitudinal direction X1 in the radiation guiding device 21 is preferably deflected by 90 degrees by total reflection at the first surface 26a of the first distal end 26 of the radiation guiding device 21 and guided to the boundary surface 10. The reflected electromagnetic radiation 8 travelled directly to the at least one detection device 7. In this embodiment, two circuit boards 13a are provided, wherein the at least one radiation source device 5 and the at least one detection device 7 are each arranged on a different circuit board.

According to the embodiment shown in FIG. 22, a plurality of containers 3 is provided for storing a liquid. Only one radiation source device 5 is provided. Furthermore, a plurality of radiation guiding devices 21 is provided, which guide electromagnetic radiation 6 of the radiation source device 5 to the respective boundary surfaces 10 of the containers 3. In the present case, two containers 3 and two radiation guiding devices 21 are provided. The two containers are arranged essentially opposite each other along a width axis Y1. The radiation guiding devices 21 are arranged above the only one radiation source device 5 and essentially perpendicular to the radiation source device 5 or the circuit board 13a. The radiation guiding devices 21 are analogous to the embodiment according to FIG. 21. However, the radiation guiding devices 21 are arranged adjacent to each other in such a way that the surfaces 26a of the distal ends 26 are opposite each other. The electromagnetic radiation of the two radiation guiding devices 21 is thus directed along the width axis Y1 in opposite directions. Furthermore, a plurality of detection devices 7 is provided. A detection device 7 is assigned to each container 3. The reflected electromagnetic radiation is thus guided from the boundary surface 10 of each container to the respectively assigned detection device 7.

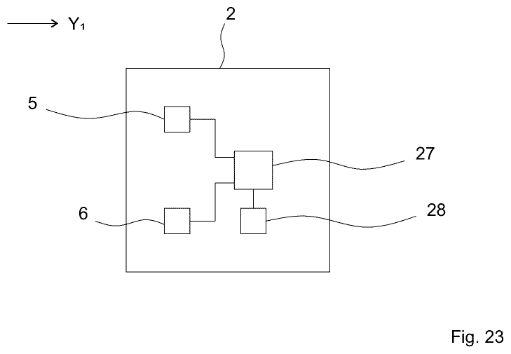

FIG. 23 schematically illustrates a household appliance 2 with a system 1 for storing liquids. The household appliance also has a control device 27, which controls the at least one radiation source device 5 and receives and processes the sensor data from the at least one detection device 7. Depending on the detected fill level, for example, a display device 28 could be controlled.

The applicant reserves the right to claim all features disclosed in the application documents as being essential to the invention, provided that they are new, either individually or in combination, compared to the prior art. It should also be noted that the individual figures also describe features which may be advantageous in themselves. The skilled person immediately recognises that a particular feature described in a figure can also be advantageous without the adoption of further features from this figure. Furthermore, the skilled person recognises that advantages can also result from a combination of several features shown in individual figures or in different figures.

### LIST OF REFERENCE SYMBOLS

1 System
2 Household appliance
3 Container
4 Level measuring device
5 Radiation source device
5a Radiation source
5b Bent wire connections
6 Emitted electromagnetic radiation
6a Central beam direction of the emitted electromagnetic radiation
7 Detection device
7a Sensor element
7b Bent wire connections
8 Reflected electromagnetic radiation
8a Central beam direction of the reflected electromagnetic radiation
9 Reflective element
9a First section of the reflective element
9b Second section of the reflective element
10 Boundary surface
11 Outer wall of the container
11a Bottom outer wall
11b Lateral outer wall
12 Optical prism
12a First lateral surface of the optical prism
12b Second lateral surface of the optical prism
12c Third lateral surface of the optical prism
13 Carrier device
13a Plate-like element/board
13b Curved board
13c Flexible board
14 First section of the board
15 Second section of the board
16 Aperture device
17 First window element
18 Second window element
19 First optical element
20 Second optical element
21 Radiation guiding device
22 Fictitious plane parallel to the level of the liquid
23 Additional interface
24 Boundary area
25 Segments
26 Distal ends of the radiation guiding device
26a Surfaces of the distal ends
27 Control device
28 Display device
α Angle of incidence
α_{T} Critical angle
β_{E} Emission angle of the radiation source device
β_{A} Acceptance angle of the detection device
γ Angle between first section and second section of the board
θ Angle between the window element and the level of the liquid
ξ Angle between the emitted electromagnetic radiation and the second side surface
ϕ_{S} Angle between the central beam direction of the at least one radiation source device the circuit board
ϕ_{D} Angle between the central beam direction of the at least one detection device and
the circuit board
X Longitudinal axis of the container
Y Width axis of the container
Z Height axis of the container
X Longitudinal axis of the prism
Y′ Width axis of the prism
Z′ Height axis of the prism

What is claimed is:

1. A system for storing liquids for a household appliance, the system comprising at least one container configured to store a liquid and at least one level measuring device, wherein the at least one level measuring device comprises at least one radiation source device configured to emit electromagnetic radiation and at least one detection device configured to detect electromagnetic radiation, wherein the at least one container has a reflective element which has only one boundary surface with a fluid located in the at least one container.

2. The system according to claim 1, characterized in that electromagnetic radiation emitted by the at least one radiation source device is incident on the boundary surface at a predetermined angle of incidence or a predetermined angle of incidence range, wherein in a first state of the system, the at least one container is not filled with liquid, wherein the fluid is air, and wherein in the first state of the system, at least a portion of the electromagnetic radiation emitted by the at least one radiation source device is totally reflected at the boundary surface and is detected by the at least one detection device.

3. The system according to claim 2, characterized in that the reflective element is arranged on or in an outer wall of the at least one container such that the boundary surface extends obliquely to a fictitious plane which is parallel to a level of the liquid in the at least one container.

4. The system according to claim 2, characterized in that the reflective element is arranged on or in an outer wall of the at least one container such that the boundary surface is substantially parallel to a level of the liquid in the at least one container.

5. The system according to claim 2, characterized in that at least one radiation guiding device is provided, wherein electromagnetic radiation emitted by the at least one radiation source device is guided in sections in the at least one radiation guiding device, and wherein electromagnetic radiation reflected at the boundary surface is guided in sections in the at least one radiation guiding device.

6. The system according to claim 1, characterized in that the at least one radiation source device comprises at least one radiation source which is a light-emitting diode (LED), a laser, or a superluminescent light-emitting diode (SLED), wherein the at least one radiation source device and the at least one detection device are arranged on a common carrier device.

7. The system according to claim 6, wherein the common carrier device comprises at least one plate-like element.

8. The system according to claim 7, wherein the at least one plate-like element is a circuit board.

9. The system according to claim 7, characterized in that a central beam direction is assigned to the at least one radiation source device and the at least one detection device, wherein the central beam direction of the at least one radiation source device and/or the central beam direction of the at least one detection device do not extend perpendicular to the at least one plate-like element.

10. The system according to claim 9, characterized in that the at least one radiation source is designed as a component with bent wire connections and the at least one detection device has a sensor element which is designed as a component with bent wire connections.

11. The system according to claim 6, characterized in that the common carrier device comprises a curved board or a flexible board, wherein the curved board or the flexible board has a first section on or at which the at least one radiation source device is arranged and a second section on or at which the at least one detection device is arranged, and wherein the first section and the second section enclose an angle less than 180°.

12. The system according to claim 11, characterized in that at least one first aperture device is provided which spatially limits electromagnetic radiation directed onto the boundary surface and at least one second aperture device is provided which spatially limits reflected electromagnetic radiation.

13. The system according to claim 1, characterized in that the reflective element is arranged in or on an outer wall of the at least one container, wherein the boundary surface is planar, curved, parabolic, or formed as a spherical section, wherein an optical element is integrated into the boundary surface, and wherein the reflective element consists of a glass or a polymer.

14. The system according to claim 1, characterized in that the reflective element comprises an optical prism, wherein a first lateral surface of the optical prism forms the boundary surface with the fluid located in the at least one container.

15. The system according to claim 1, characterized in that the at least one radiation source device has an emission angle and the at least one detection device has an acceptance angle, wherein the at least one radiation source device is arranged relative to the boundary surface such that only a portion of the electromagnetic radiation within the emission angle impinges on the boundary surface, and wherein the at least one detection device is arranged relative to the boundary surface such that only a portion of the resultant reflected electromagnetic radiation lies within the acceptance angle.

16. The system according to claim 15, wherein the at least one radiation source device is approximately a Lambert radiator and the at least one detection device is approximately a Lambert detector, and wherein a half emission angle is greater than or equal to 45° and a half acceptance angle is greater than or equal to 45°.

17. The system according to claim 1, characterized in that a first window element is arranged between the at least one radiation source device and the boundary surface and a second window element is arranged between the boundary surface and the at least one detection device.

18. The system according to claim 1, characterized in that a first optical element is arranged on or near the at least one radiation source device and a second optical element is arranged on or near the at least one detection device, wherein the first optical element and/or the second optical element is a prism or a lens.

19. The system according to claim 1, characterized in that the at least one container comprises a plurality of containers and the at least one radiation source device is only a single radiation source, wherein a plurality of radiation guiding devices are provided which guide electromagnetic radiation from the single radiation source to respective boundary surfaces of the plurality of containers, and wherein the at least one detection device comprises a plurality of detection devices respectively assigned to each container.

20. A household appliance comprising the system according claim 1.
